(19) United States
(12) Patent Application Publication
(10) Pub. No.: US 2015/0310387 A1
(43) Pub. Date: Oct. 29, 2015

(54) Systems and Methods for Routing Return Products to Subsequent Purchasers

(71) Applicant: MASTERCARD INTERNATIONAL INCORPORATED, Purchase, NY (US)

(72) Inventors: Michael Friedman, Stamford, CT (US); Stephen Parento, White Plains, NY (US)

(73) Assignee: MASTERCARD INTERNATIONAL INCORPORATED, Purchase, NY (US)

(21) Appl. No.: 14/260,984

(22) Filed: Apr. 24, 2014

(51) Int. Cl. G06Q 10/08; G06Q 30/06

(52) U.S. Cl. CPC G06Q 10/0837; G06Q 30/0633

(57) ABSTRACT

Disclosed are exemplary embodiments of systems and methods for routing return products from prior purchasers to subsequent purchasers. In an exemplary embodiment, a method generally includes receiving a search request for a target product, identifying a return product associated with the target product, in response to the search request, the return product designated for return from a prior purchaser to a seller of the return product, but not yet received by the seller, receiving a purchase request for the return product, the purchase request indicating a subsequent purchaser, and issuing an instruction, to a courier in possession of the return product and/or the prior purchaser of the return product, to route the return product to the subsequent purchaser.

### FIELD

The present disclosure relates to systems and methods for routing return products from prior purchasers to subsequent purchasers, rather than back to sellers of the return products.

### BACKGROUND

This section provides background information related to the present disclosure which is not necessarily prior art.

Products can be purchased from sellers in a variety of different ways. For example, a product may be purchased through a catalog or a website associated with a seller. When a purchaser is dissatisfied with the product, or otherwise decides not to keep the product, the purchaser may return the product to the seller. The product may be returned to the seller in multiple ways, including by returning the product in-person at the seller's retail location. More frequently, especially for Internet purchases, the product may be shipped, via a courier, such as UPS®, FedEx®, DHL®, etc., back to the seller.

### DRAWINGS

The drawings are for illustrative purposes only of selected embodiments and not all possible implementations, and are not intended to limit the scope of the present disclosure.

FIG. 1 is a block diagram of an exemplary system for use in routing return products to subsequent purchasers.

FIG. 2 is a block diagram of a computing device, that may be used in the exemplary system of FIG. 1

FIG. 3 is an exemplary method for routing return products from prior purchasers to subsequent purchasers.

FIG. 4 is an exemplary page for a target product including an option to purchase a return product.

FIG. 5 is another exemplary page illustrating available return products.

Corresponding reference numerals indicate corresponding parts throughout the several views of the drawings.

### DETAILED DESCRIPTION

Example embodiments will now be described more fully with reference to the accompanying drawings.

The inventors hereof have recognized that a return product being shipped from a prior purchaser back to a seller often involves inefficient transfer of the return product, because the return product is transported back to the seller, and then later, shipped out to a subsequent purchaser. The systems and methods described herein are provided to route the return product to a subsequent purchaser, rather than back to the seller of the return product, thereby improving efficiency of the routing of the return product.

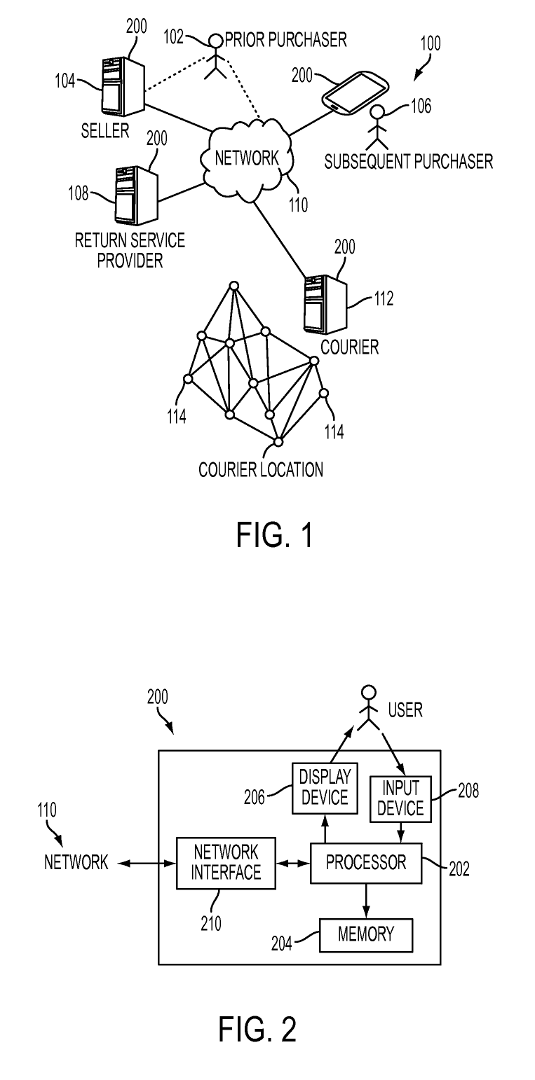

FIG. 1 illustrates an exemplary system 100, in which one or more aspects of the present disclosure may be implemented. Although, in the described embodiment, the system 100 is presented in one arrangement, other embodiments may include systems arranged otherwise. As shown, the system 100 generally includes a prior purchaser 102, a seller 104, a subsequent purchaser 106, and a return service provider 108. It should be appreciated that while the return service provider 108 is illustrated separate from the seller 104, in at least one embodiment, the return service provider 108 may be integral with the seller 104. As shown in FIG. 1, each of the seller 104 and the return service provider 108 are coupled to a network 110. The network 110 may include, without limitation, a local private intranet, a local area network (LAN), a wide area network (WAN, e.g., the Internet, etc.), a mobile network, a virtual network, and/or another suitable network capable of supporting the communication described herein.

The system 100 further includes a courier 112, which is also coupled to the network 110. The courier 112 may include any delivery service entity, such as UPS®, FedEx®, DHL®, or others in the business of delivering products from one location to another. In this particular embodiment, the courier 112 is distributed geographically across multiple courier locations 114. When a product is in transit, by the courier 112, the product is moved through one or more courier locations 114 to its destination. In transit, products may be scanned by the courier 112, thereby permitting the courier 112 to substantially track the product from its origin up until the product is delivered to its destination.

FIG. 2 illustrates an exemplary computing device 200. In the exemplary embodiment of FIG. 1, each of the seller 104, the return service provider 108, and courier 112 are illustrated as computing devices, coupled to the network 110. Further, as shown in FIG. 1, computing devices associated with the prior purchaser 102 and the subsequent purchaser 106 are coupled to the network 110. The computing device 200 may include, for example, one or more servers, personal computers, laptops, tablets, PDAs, smartphones, etc. The system 100, and its components, should not be considered to be limited to the computing device 200, as described below, as different computing devices and/or arrangements of computing devices may be used. In various embodiments, the seller 104, for example, includes multiple computing devices located in close proximity, or distributed over a geographic region. Additionally, the courier 112 may include multiple computing devices distributed geographically, and/or in some embodiments, at least one computing device at each courier location 114.

Referring again to FIG. 2, the computing device 200 includes a memory 204 and a processor 202 that is coupled to memory 204. The processor 202 may include one or more processing units (e.g., in a multi-core configuration, etc.). The processor 202 may include, but is not limited to, a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions or processes described herein.

Memory 204, as described herein, is one or more devices that enable information such as executable instructions and/or other data to be stored and retrieved. Memory 204 may include one or more computer-readable media, such as, without limitation, dynamic random access memory (DRAM), static random access memory (SRAM), a solid state disk, and/or a hard disk. Memory 204 may be configured to store, without limitation, tracking data, return tickets, payment information, incentives, and/or any other type of data suitable for use as described herein. Furthermore, in various embodiments, computer-executable instructions may be stored in memory 204 for execution by the processor 202 to cause the processor 202 to perform one or more of the functions described herein, such that memory 204 is a physical, tangible, and non-transitory computer-readable media. It should be appreciated that memory 204 may include a variety of different memories, each implemented in one or more of the functions or processes described herein.

In the exemplary embodiment, computing device 200 includes a display device 206 that is coupled to the processor 202. Display device 206 outputs to a user by, for example, displaying and/or otherwise outputting information such as, but not limited to, pages, incentives, options for purchase return products, and/or any other type of data. For example, display device 206 may include, without limitation, a cathode ray tube (CRT), a liquid crystal display (LCD), a light-emitting diode (LED) display, an organic LED (OLED) display, and/or an “electronic ink” display. In some embodiments, display device 206 includes multiple devices. The computing device 200 includes an input device 208 that receives input from the user, such as a purchaser. The input device 208 is coupled to the processor 202 and may include, for example, a keyboard, a pointing device, a mouse, a stylus, a touch sensitive panel (e.g., a touch pad or a touch screen, etc.), and/or an audio input device. Further, in various exemplary embodiments, a touch screen, such as that included in a tablet, a smartphone, or similar device, behaves as both display device 206 and input device 208.

As shown, the computing device 200 also includes a network interface 210 coupled to the processor 202. Network interface 210 may include, without limitation, a wired network adapter, a wireless network adapter, a mobile telecommunications adapter, or other device capable of communicating to one or more different networks, including the network 110. In various embodiments, the network interface 210 may be integrated with, or separate from the processor 202, for example.

Referring again to FIG. 1, the seller 104 offers products for sale, while the purchasers 102/106 buy products. For a variety of different reasons, a prior purchaser 102 may decide to return a product after purchase. In various embodiments, this prior purchaser 102 returns the product in-person or through the courier 112 to the seller 104. If the product is sent, via the courier 112, the product may be routed back to the seller 104. The methods and systems described herein relate to routing the return product to a subsequent purchaser 106, rather than back to the seller 104, thereby improving efficiency of the routing of return product.

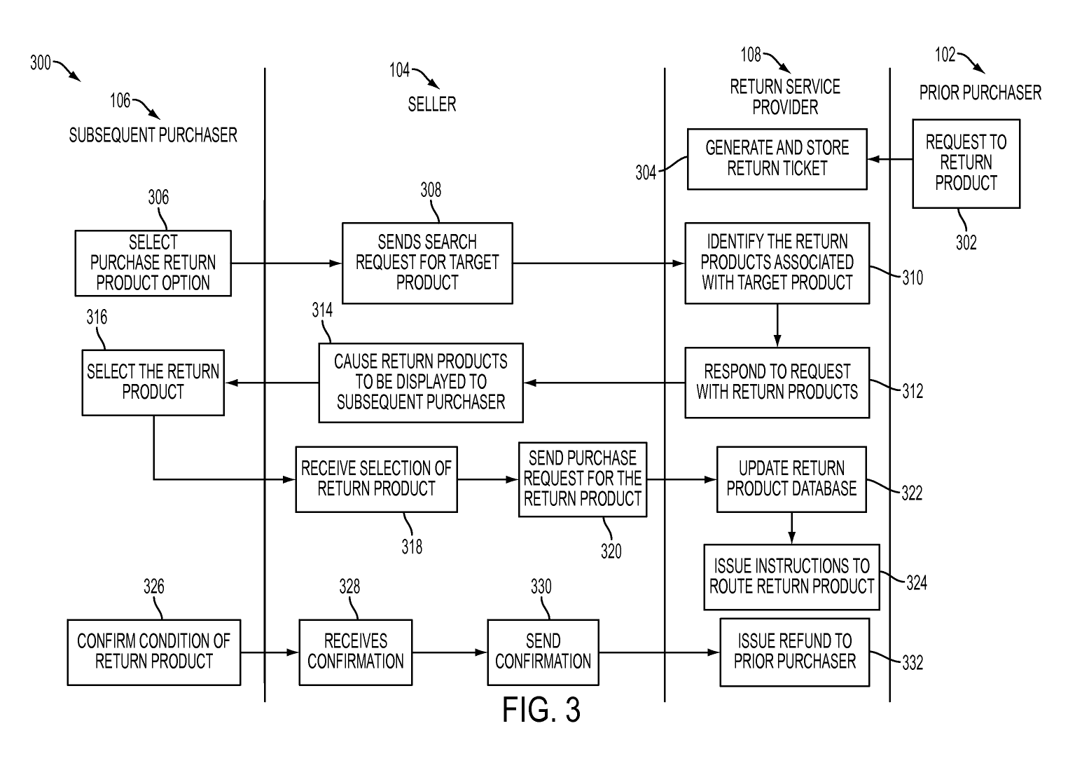

FIG. 3 illustrates an exemplary method for routing the return product from a prior purchaser to a subsequent purchaser. The method, as shown in FIG. 3, is described with reference to the prior purchaser 102, the seller 104, the subsequent purchaser 106 and the return service provider 108, as shown in FIG. 1. It should be appreciated that the exemplary method 300 may be implemented in other systems, or arrangements of systems. For example, while the return service provider 108 is illustrated as separate, in one or more embodiments, the return service provider 108 may be implemented as part of the seller 104, the courier 112, or another entity. Just as the methods herein should not be understood to be limited to the exemplary system 100, or the exemplary computing device 200, the systems and the computing devices herein should not be understood to be limited to the exemplary method 300. Further, the steps of the methods herein should be understood to be performed by one or more computing devices 200 (in particular, one or more processors 202) associated with the respective seller 104, return service provider 108, and/or purchaser 102/106.

Referring to FIG. 3, upon determining to return a product, in this embodiment, the prior purchaser 102 requests return of the product at 302. The request may be directed to the seller 104, or the return service provider 108. In this example, the request is directed to the return service provider 108. The request may be electronic (e.g., via email or a prior purchaser's account with the seller's website linked to the return service provider 108, etc.), or may, in some examples, be telephonic or otherwise. When the request is received, the return service provider 108 generates a return ticket for the return product and stores the return ticket in memory, at 304. The return ticket may include a variety of details related to the return product, including, without limitation, an identity and/or a location of the prior purchaser 102, a model number and/or description of the return product, a condition of the return product, a reason for return of the product, etc.

In some embodiments, the return service provider 108 provides return instructions to the prior purchaser 102 in response to the return request. For example, the return service provider 108 may instruct the prior purchaser 102 to ship the return product to the seller 104 and further provide a shipping label, which may be affixed to the return product to route it to the seller 104 (including a shipping depot, intermediary, or distribution center associated with the seller 104, etc.). In another example, the return service provider 108 may instruct the prior purchaser 102 to hold the return product for a period of time, such as a day, a week or two weeks, etc., prior to shipping the return product back to the seller 104. In this manner, the return service provider 108 is allotted more time to identify a subsequent purchaser 106 to route the return product, rather than promptly routing it to the seller 104. In exchange, the return service provider 108 may offer the prior purchaser 102 an incentive, such as, for example, free pickup at the prior purchaser's location.

As the return service provider 108 receives additional requests to return products from different prior purchasers, it generates and stores further return tickets. The return tickets may be related to a variety of different products for a variety of different sellers 104. The stored return tickets form, in some embodiments, a database of return products, i.e., a return product database. Each product in the return product database is designated for return from a prior purchaser 102 to a seller 104 of the return product, but not yet received by the seller 104. The return products are generally in-transit from the prior purchaser 102 to the seller 104, or being held (for a time period) by the prior purchaser 102 prior to being shipped. When return the product arrives at the seller 104, in this example, the product may be removed from the return product database to ensure it contains only products suitable to be routed to a subsequent purchaser. In one or more examples, when removed from the database, the return service provider 108 or seller 104 may move the return tickets to another database associated with return of products. Alternatively, the received products may be maintained in the database, but designated “received” in some manner to avoid the return service provider 108 from identifying the return product.

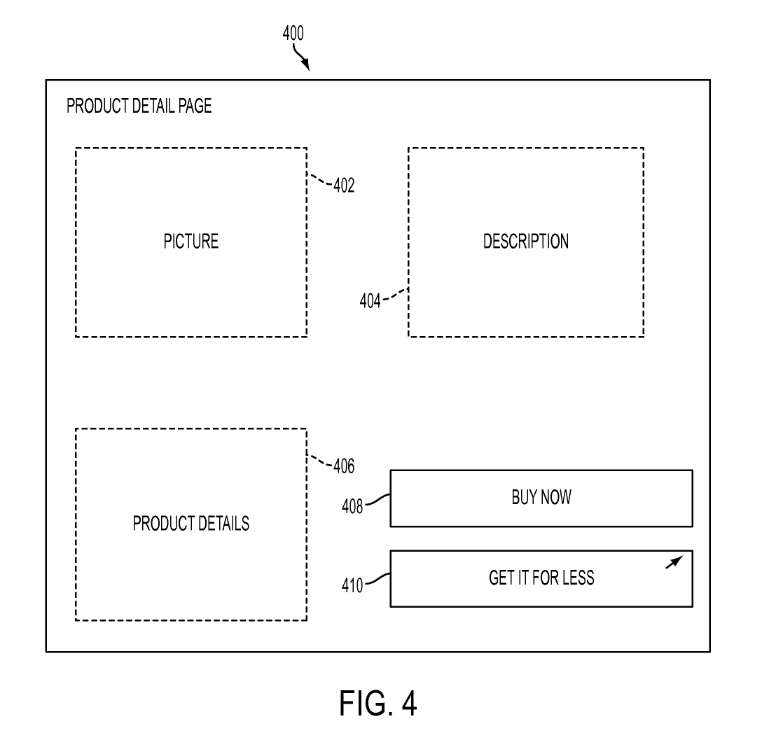

As the return ticket database is populated with return tickets, the return service provider 108 responds to search requests for target products from purchasers (e.g., subsequent purchaser 106), directly or indirectly. As shown in FIG. 3, the return service provider 108 receives requests for a target product through the seller 104. More specifically, in this embodiment, the seller 104 employs a website, through which it sells products. The website is generally hosted by a computing device 200 associated with the seller 104, whether managed by the seller 104 or a third party associated with the seller 104. The website includes different pages associated with different products for sale from the seller 104. FIG. 4 illustrates an exemplary page 400 for a product, i.e., a target product, offered for sale on the seller's website. As shown, the page includes an image 402 of the product, a description of the product 404, and product details 406. The page further includes, in this example, the option to “Buy Now” 408 and the option to “Get it for less” 410. If a purchaser selects the “Buy Now” option, he/she is directed through a traditional purchase procedure. If, however, a purchaser selects the “Get it for less” (or the purchase return product option) at 306, the seller 104 receives a search request for the target product (i.e., selected by the subsequent purchaser 106), and in turn, sends the search request for the target product at 308 to the return service provider 108.

It should be noted that page 400 is merely exemplary, and that a variety of other pages may be provided through a seller page to advertise, promote, or offer for sale a product, with a variety of different arrangements, formats and/or options to display, describe or purchase a target product. For example, the options to “Buy Now” or “Get for Less” may be present only after a purchaser has selected the product for purchase, in a virtual shopping cart, and/or during checkout. By altering the time when the website sends a search request to the return service provider 108, the number of searches and/or data flow between the return service provider 108 and the web site may be changed. For example, if the search request is not sent until a purchase is imminent (e.g., in the virtual cart), the search requests will be reduced, but the subsequent purchaser 106 may be denied certain information (e.g., incentive, availability, etc.) during his/her initial decision to purchase or not purchase. The timing of the search request from the seller 104 may be adjusted based on a variety of factors, including, for example, type and/or cost of products, type of seller, etc.

Referring again to FIG. 3, in response to the search request for the target product from the seller 104 (or subsequent purchaser 106), the return service provider 108 identifies one or more return products associated with the target product at 310. Return products may be associated with the target product because they are the same as the target product, or alternatively, because they are substitutes for the target product. For example, where the target product is a stainless steel Brand-X blender, identified return products may include stainless steel Brand-X blenders (i.e., same as the target product), stainless steel Brand-A blenders (i.e., a substitute brand), green Brand-X blender (i.e., a substitute color), red Brand-K blender (i.e., a substitute brand and color), etc.

Further, the return service provider 108 may associate return products based on a location of the return products, and/or the location of the subsequent purchaser 106. In one example, a return service provider 108 may avoid associating a return product in California, where the subsequent purchaser 106 is in New York. Further, in various embodiments, the return service provider 108 may retrieve tracking data, from the courier 112, for the return product. The tracking data may be retrieved, for example, regularly for return products in the return products database, or discretely only in response to a search request from the subsequent purchaser 106. The tracking data may include, without limitation, an expected delivery route, a current location, a last scanned location, an origin and/or destination, an estimated time of arrival (ETA) to one or more courier locations 114, an ETA to the seller 104, etc. In this manner, the return service provider 108 may, in some examples, only associate return products, where the expected delivery route of the return product passes within a certain radius (e.g., 5, 10, 50, or 100 miles, etc.) of the subsequent purchaser's location. In yet another example, the return service provider 108 may associate all return products that are the same as the target product, and/or substitutes for the target product, to provide subsequent purchaser 106 more options.

It should be appreciated that any variety of different criteria may be used to associate or not associate a return product in the return product database with a target product, generally, or specifically for a subsequent purchaser 106.

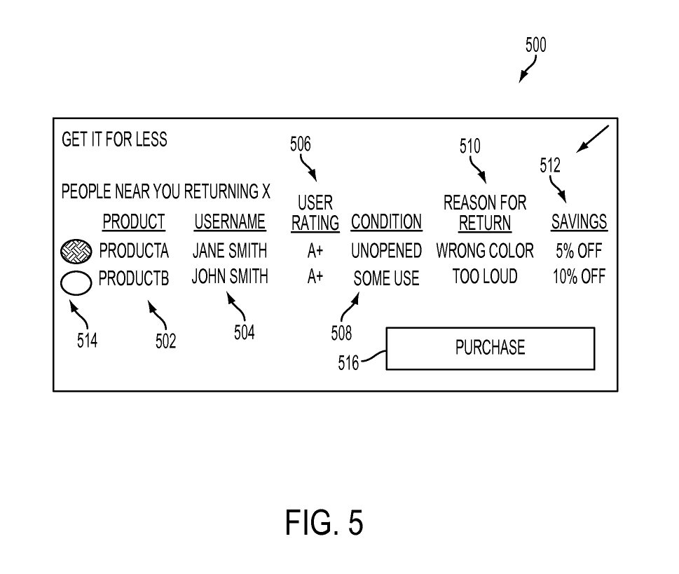

Once a return product associated with the target product is identified at 310, the return service provider 108 responds to the search request with the return products at 312 to the seller 104. In this exemplary embodiment, the seller 104, in turn, causes another example page 500, shown in FIG. 5, to be displayed at 314 to the subsequent purchaser 106, incorporating the return products associated with the target product. It should be appreciated that where the seller 104 and return service provider 108 are sufficiently integrated, return products identified, in response to the search request, may be directly incorporated into the page 400 displayed to the subsequent purchaser 106, without being communicated therebetween.

In displaying the return product to the subsequent purchaser 106, as shown in FIG. 5, the page 500 may include, for example, the return product 502, the username 504 of the prior purchaser 102, a rating 506 of the prior purchaser 102, a location of the prior purchaser 102, a condition 508 of the return product, and a reason 510 for the return. It should be appreciated that, in other embodiments, the same or different information may be displayed about the return product. In one example, the username and user rating are omitted. In additional to details of the return product, the seller 104, or the return service provider 108, may offer or include an incentive to purchase a return product. As shown in FIG. 5, for example, the seller 104 may offer a discount 512 (e.g., 5%, 10%, etc.) to the subsequent purchaser 106 to purchase a return product. Further incentives might include, for example, free or discounted shipping, reward points associated with a seller or a method of payment, extended warrantee, discounts on one or more other products, coupons, etc. It should be appreciated that a seller 104, or return service provider 108, may include a variety of different incentives, either alone or in combination, to incentivize the subsequent purchaser 106 to select the return product. Moreover, different return products may include different incentives. For example, an unopened return product may include a 5% discount, where an opened return product may include a 10% discount (as shown in FIG. 5).

Subsequently, if the subsequent purchaser 106 decides to purchase one of the return products, the subsequent purchaser 106 selects at 316 the return product by selecting one of the radio buttons 514 and clicking the “Purchase” button 516. Payment information is entered by the subsequent purchaser 106 and received through one or more additional pages, and directed to the seller 104 or the return service provider 108. The payment information may be handled by the seller 104, or the return service provider 108. In either instance, upon purchase, in this example, the seller 104 receives at 318 a selection of the return product for purchase and sends at 320 the selection of the return product to the return service provider 108. The seller 104 further sends payment information for the return product and/or subsequent purchaser 106. In response, the return service provider 108 processes the payment and holds the funds.

As shown in FIG. 3, in this exemplary embodiment, the return service provider 108 then updates at 322 the return products database, and in particular the return ticket for the selected return product. The return service provider 108 further issues an instruction at 324 to route the return product to the subsequent purchaser 106. The instruction may be issued, for example, to the courier 112, where the courier 112 is in possession of the return product. In response, depending on the location of the return product, the courier 112 may route the return product from a next courier location 114 receiving the return product to the subsequent purchaser 106, at a location indicated by the instruction.

Alternatively, where the return product is in the possession of the prior purchaser 102, the instruction maybe issued to the prior purchaser 102, and include, for example, a shipping label to be attached to the return product and/or an indication regarding when the return product will be collected, or direction to deliver the return product to a particular courier location 112. Again, in one or more embodiments, the return service provider 108 may offer the prior purchaser 102 an incentive to cooperate in holding the return product for the time interval, including, for example, providing free product pickup at the prior purchaser's location, etc.

Upon receipt of the return product, the subsequent purchaser 106 confirms the return product was delivered and, in some examples, confirms the condition of the product at 326. It should be appreciated that a variety of different confirmations, including from prior purchaser 102, subsequent purchaser 106, the courier 112, etc., may be included in the various embodiments to reduce the risk of one or more issues. Such issues may include, for example, damaged goods being passed on from the prior purchaser 102 to the subsequent purchaser 106, the subsequent purchaser 106 denying the receipt of the return product, etc. In the exemplary embodiment, when the seller 104 receives confirmation of the return product from the subsequent purchaser 106 at 328, the seller 104 provides confirmation to the return service provider 108 at 330.

In turn, the return service provider 108 provides a full or partial refund at 332 to the prior purchaser 102 for return of the product. In various embodiments, where the seller 104 is involved in payment, the seller 104 may issue a full or partial refund, upon confirmation from the subsequent purchaser 106 or other criteria. It should be appreciated that in one or more embodiments, the seller 104 may be charged a commission by the return service provider 108, and/or the seller 104 may reimburse the return service provider 108 for the incentive offered to the subsequent purchaser 106 and/or pay costs associated with courier 112.

It should be appreciated that the functions described herein, in some embodiments, may be described in program instructions stored on a computer readable media, and executable by one or more processors. The computer readable media is a non-transitory computer readable media. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) receiving a search request for a target product, (b) identifying a return product associated with the target product, in response to the search request, the return product designated for return from a prior purchaser to a seller of the return product, but not yet received by the seller, (c) receiving a purchase request for the return product, the purchase request indicating a subsequent purchaser, (d) issuing an instruction, to a courier in possession of the return product and/or the prior purchaser of the return product, to route the return product to the subsequent purchaser.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in routing a return product from a prior purchaser to a subsequent purchaser, the method comprising:
receiving a search request for a target product;
identifying, at a computing device, a return product associated with the target product, in response to the search request, the return product designated for return from a prior purchaser to a seller of the return product, but not yet received by the seller;
receiving a purchase request for the return product, the purchase request indicating a subsequent purchaser; and
issuing an instruction, to a courier in possession of the return product and/or the prior purchaser of the return product, to route the return product to the subsequent purchaser.

2. The computer-implemented method of claim 1, further comprising causing to be displayed, at a computing device associated with the subsequent purchaser, at least one detail pertaining to the return product and at least one incentive to purchase the return product.

3. The computer-implemented method of claim 1, wherein identifying the return product includes identifying multiple return products based on a location of each of the multiple return products; and
wherein receiving the purchase request for the return product includes receiving the purchase request for one of the multiple return products.

4. The computer-implemented method of claim 1, wherein identifying the return product includes retrieving tracking data, from the courier, for the return product, including an expected delivery route, and identifying the return product from multiple return products, based on the expected delivery route and a location of the subsequent purchaser.

5. The computer-implemented method of claim 1, further comprising receiving confirmation of the return product from the subsequent purchaser and releasing a refund to the prior purchaser based on the verification.

6. The computer-implemented method of claim 1, wherein the return product is a substitute for the product for purchase, but not the same as the product for purchase.

7. The computer-implemented method of claim 1, wherein the return product is the same as the product for purchase.

8. A system for routing a return product from a prior purchaser to a subsequent purchaser, the system comprising:
one or more processors for executing program instructions and computer readable non-transitory media carrying program instructions, the program instructions executable by the one or more processors to:
receive a search request for a target product;
identify, in a non-transitory media, return products associated with the target product, the return products in said non-transitory media being in-transit from a prior purchaser to a seller of the return product, but not yet received by the seller;
receive a purchase request selecting one of the return products, the purchase request indicating a subsequent purchaser for the selected return product; and
issue an instruction to a courier in possession of the selected return product to route the selected return product to the subsequent purchaser.

9. The system of claim 8, wherein the program instructions executable by the one or more processors to cause to be displayed, at a computing device associated with the subsequent purchaser, a page including at least one detail pertaining to the return product and at least one incentive for purchasing the return product.

10. The system of claim 8, wherein the program instructions executable by the one or more processors to cause to be displayed, at a computing device associated with the subsequent purchaser, details related to the return products and, for each return product, an incentive for purchasing the return product.

11. The system of claim 10, wherein the incentive is based on at least one detail of the return product, the incentive for one of the return products being different for the incentive for another one of the return products.

12. The system of claim 8, wherein the program instructions executable by the one or more processors to associate return products with the target product based on a location of each return product and a location of the subsequent purchaser.

13. The system of claim 8, wherein the program instructions executable by the one or more processors to cause to be displayed, at a computing device associated with the subsequent purchaser, a page including a purchase return product option, and to receive the search request for the target product, when the subsequent purchaser selects the purchase return product option.

14. The system of claim 8, wherein the program instructions executable by the one or more processors to process payment for the return product from the subsequent purchaser, and issue an at least partial refund to the prior purchaser.

15. The system of claim 8, wherein the program instructions executable by the one or more processors to receive a request to return a product from a prior purchaser and to store, in the non-transitory media, a return ticket, in response to the request, the return ticket indicating for the return product, each return ticket including details related to the return product; and
wherein the courier in possession of the selected return product is indicated in the return ticket associated with the selected return product.

16. A non-transitory computer readable media comprising instructions executable that, when executed by at least one processor, cause the at least one processor to:
identify, in a return product database, a first return product that is the same as a target product requested by a subsequent purchaser;
cause to be displayed, at a computing device associated with the subsequent purchaser, details about the first return product and an incentive to purchase the first return product; and
issue an instruction, to a courier associated with the first return product, to route the first return product to the subsequent purchaser, when the subsequent purchaser purchases the first return product.

17. The non-transitory computer readable media of claim 16, wherein the instructions executable that, when executed by the at least one processor, cause the at least one processor to remove a second return product from the return product database, after the second return product is received by the seller.

18. The non-transitory computer readable media of claim 16, wherein the instructions executable that, when executed by the at least one processor, cause the at least one processor to refund payment to the prior purchaser, when the subsequent purchaser confirms receipt of the first return product.
